(19) United States
(12) Patent Application Publication
(10) Pub. No.: US 2023/0042799 A1
(43) Pub. Date: Feb. 9, 2023

(54) UNDERGROUND HYDRAULIC SYSTEM

(71) Applicant: Hans Gude GUDESEN, Gamle Fredrikstad (NO)

(72) Inventor: Hans Gude GUDESEN, Gamle Fredrikstad (NO)

(21) Appl. No.: 17/782,638

(22) PCT Filed: Dec. 2, 2020
(86) PCT No.: PCT/NO2020/050296

§ 371 Date: Jun. 3, 2022

(30) Foreign Application Priority Data
Dec. 5, 2019 (GB) 1917778.1

(51) Int. Cl. F03G 4/00; E02B 9/06; F24T 10/20; F24T 10/40; F03B 13/08

(52) U.S. Cl. CPC F03G 4/026; F03G 4/072; E02B 9/06; F03G 4/037; F24T 10/20; F24T 10/40; F03B 13/08

(57) ABSTRACT

An underground hydraulic system is disclosed, the system comprising an intake tunnel (2) connected to a body of water (1), a control unit (3) arranged to control flow of water from the body of water (1) into the intake tunnel (2), a distribution tunnel (5) connected to the intake tunnel (2), and at least one riser tunnel (6) connected at a lower end to the distribution tunnel (5), and arranged for receiving water from the distribution tunnel (5).

### FIELD OF THE INVENTION

The present invention relates to an underground infrastructure and method for transporting water from an abundant source of water such as the sea or a lake and exposing it to deep lying sources of geothermal heat, and further for transporting heated water to facilities on the surface and/or at depth where the thermal energy is used for desalination, electrical energy generation or other purposes. More generally it relates to an underground hydraulic system.

### SUMMARY OF THE INVENTION

A first aspect of the invention is an underground hydraulic system arranged in a landmass, comprising an intake tunnel connected to a body of water with a surface, where the intake tunnel comprises an intake opening at one end and inclines towards an outlet opening at the other end, where the intake opening provides access to the intake tunnel for water from the body of water. The system further comprises a control unit arranged to control flow of water from the body of water into the intake tunnel, a distribution tunnel connected to the intake tunnel at the outlet opening, and arranged at an average depth h₁ below the surface of the body of water which is greater than that of the intake opening, where the distribution tunnel is arranged at least partially in a geological layer with a temperature in a range of 40° C. and above, geothermally heating water in the distribution tunnel, and at least one riser tunnel connected at a lower end to the distribution tunnel and extending towards the surface of the landmass, where the at least one riser tunnel is arranged for receiving water from the distribution tunnel, where water in the riser tunnel is pumped up by the hydrostatic pressure at the lower end of the at least one riser tunnel (6), generated by the cumulative head of water through the body of water (1), the intake tunnel (2) and the distribution tunnel (5), and in addition one or more of the following: the gas lift effect, and the thermally generated density differential effect.

Optionally, h₁ is larger than 1 km.

Optionally, the underground hydraulic system further comprising the following:

a user unit connected to the riser tunnel, allowing water in the riser tunnel entering the user unit; and

a riser control unit arranged related to the riser tunnel, the riser control unit controlling water flow into the user unit above.

Optionally, the underground hydraulic system comprises a mechanical pump arranged for assisting in pumping water upwards in the riser tunnel.

Optionally, the control unit comprises at least one of the following: filtration systems and sensors for parameters. The parameters can comprise at least one of the following: salinity, temperature, turbidity and pressure.

Optionally, the underground hydraulic system further comprises a turbine unit arranged related to one of the tunnels for producing hydroelectric energy from water flow in the tunnel.

Optionally, the underground hydraulic system further comprises:

a second distribution tunnel essentially parallel to the first distribution channel, but at less depth h₂, below the surface of the body of water transporting water under hydrostatic pressure from the body of water, and connected at branching off points to one or more of the riser control units.

Optionally, the underground hydraulic system further comprises at least one water transport loop comprising at least one user unit being connected to a turbine tunnel where water from the riser tunnel is redirected from the user unit and through a water turbine located in the turbine tunnel, and where a lower part of the turbine tunnel connects with a distribution tunnel which delivers water to a second water transport loop in a chain of two or more loops, in which the last user unit in the chain drains water from the chain by transporting the received water away or by re-injecting the water into the first user unit in the chain.

### DESCRIPTION OF THE DIAGRAMS

Embodiments of the present invention will now be described, by way of example only, with reference to the following diagrams wherein:

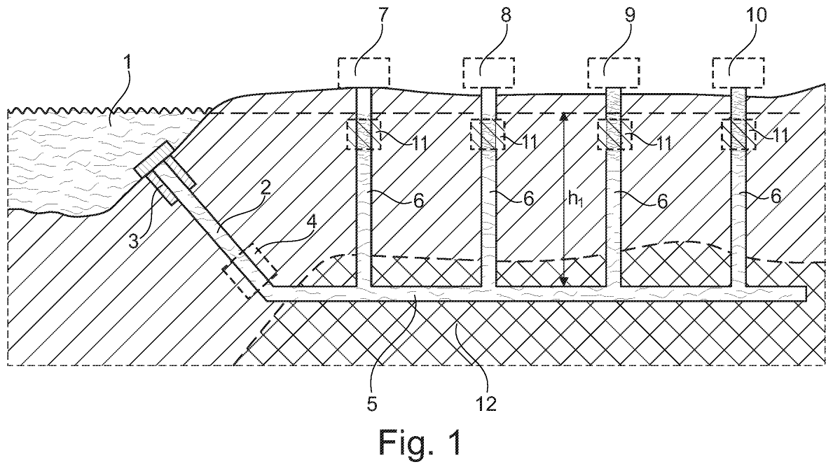

FIG. 1 discloses a version of the underground hydraulic system according to the present invention.

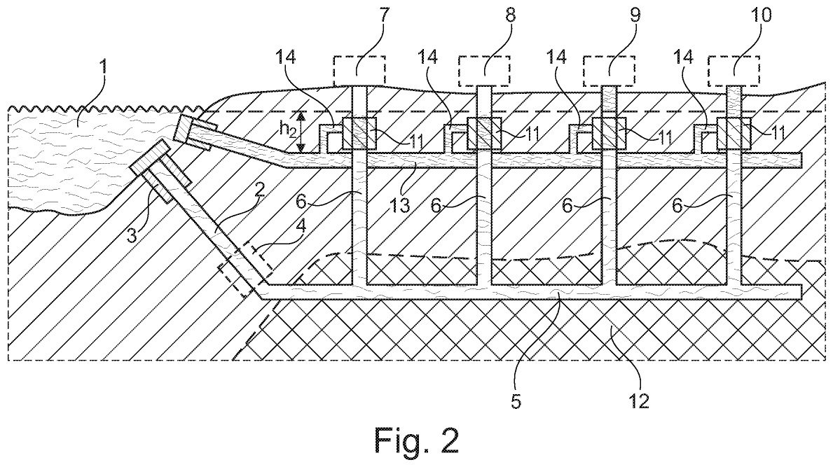

FIG. 2 discloses an embodiment with a separate tunnel for transporting cold water.

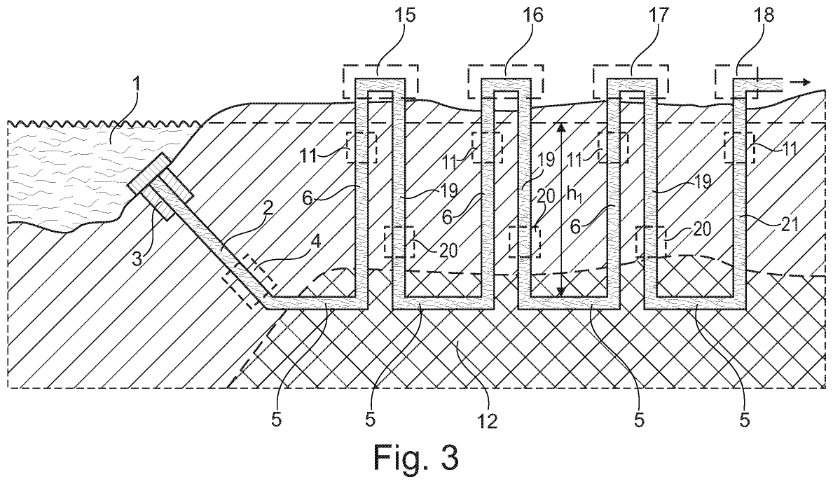

FIG. 3 discloses an embodiment of the present invention with a chain of coupled pumping and hydropower loops.

### LIST OF REFERENCE NUMBERS IN FIGURES

| Number | Designation |
|---|---|
| 1 | Body of water |
| 2 | Intake tunnel |
| 3 | Control unit |
| 4 | Turbine unit |
| 5 | Distribution channel |
| 6 | Riser tunnel |
| 7 | User unit |
| 8 | User unit |
| 9 | User unit |
| 10 | User unit |
| 11 | Control unit |
| 12 | Geological structure |
| 13 | Parallel cold water tunnel |
| 14 | Branching off point |
| 15 | User unit |
| 16 | User unit |
| 17 | User unit |
| 18 | User unit |
| 19 | Turbine tunnel |
| 20 | Turbine |
| 21 | Riser tunnel |

### DESCRIPTION OF PREFERRED EMBODIMENTS OF THE INVENTION

The present invention employs gradients in water temperatures and pressures in a deep underground hydraulic system to transport water from an abundant source such as the sea or a lake across large distances to remote inland locations, to heat the water in deep geological structures, and to pump steam and hot water to facilities on the surface. Temperatures of the steam and water entering the surface facilities are typically in the range 150-250° C., suitable for desalination, electric energy production, or other applications. The system is driven by geothermal heat extracted from the underground in conjunction with gravity-driven transport.

FIG. 1 illustrates the general concept: Water is drawn from a large body of water (1), which may be the sea or a lake, and flows by gravity into an underground hydraulic system that transports water, heats it up and provides access to the hot water via riser tunnels at selected locations.

The major parts of the hydraulic system are the following:

i) An intake tunnel (2) connects the body of water (1) with the underground hydraulic system. A control unit (3) controls the flow of water and incorporates technical equipment, including filtration systems and sensors for parameters such as salinity and temperature. A turbine unit (4) produces hydroelectric energy from the water flow.

ii) An essentially horizontal distribution tunnel (5) transports the water to locations inland. The distribution tunnel typically has a large cross section and a length L which may extend across large distances. It is located at a depth h₁ below the surface of the body of water (1).

iii) Riser tunnels (6) that receive water from the distribution tunnel. Four riser tunnels are shown in FIG. 1, each being positioned and adapted for providing water to a separate user unit (7), (8), (9), (10) on the surface. In a passive gravity-driven communicating tube system, the water levels in the riser tunnels will adjust to a common value, equal to that of the body of water (1), cf. levels in the riser channels under user units (7) and (8). During operations, however, water shall be transported to the surface and enter the user units, cf. levels shown for user units (9) and (10) in FIG. 1. Each riser tunnel is provided with a riser control unit (11), which controls the water flow into the user units above.

The distribution channel (5) is located at considerable depth, typically up to several kilometers, in a geological structure (12) which is characterized by high geothermal heat content. In operation, water from the intake tunnel (2) flows through the tunnel system in the geological structure and heats up, typically to 150-250 degrees C. Due to the high hydrostatic pressure at this depth, the water does not boil, but will experience buoyancy relative to the colder water in the riser tunnels as long as it maintains a high temperature. When a control unit (11) is activated, it opens for a flow of water from the riser tunnel and into the user unit above. The flow may be initiated by pumps that draw water from the riser tunnel and lift it into the user unit. This imbalances the water column in the riser tunnel, which is replenished from below by gravity-fed hot water from the distribution channel (5). This water is subject to the hydrostatic pressure generated by the water column in the body of water (1) and the intake tunnel (2), which is at ambient temperatures and therefore more dense than the water in the riser tunnels. This generates an imbalance which favors the water in the riser tunnel to be lifted by the thermally generated density differential, or hot water buoyancy effect. As the hot water rises in the riser channel, it experiences a lower hydrostatic pressure, and ultimately starts boiling. The bubbles float up through the riser tunnel, providing a pumping action. This pumping effect, which has variously been termed as the “Gas lift” or “Geyser” or “Bubble pump” effect, is well known and has been explained by entrainment of water by rising bubbles in a column of liquid and/or by reduced density of a gas bubble admixed liquid in hydrostatic contact with a column of non bubble admixed liquid (cf. e.g. Wikipedia “Gas lift”: https://en.wikipedia.orq/wiki/Gas_lift and A. Benhmidene et al.: “A Review of Bubble Pump Technologies”, Journal of Applied Sciences 10 (16): 1806-1813, 2010). Recently it has been proposed to exploit the effect in connection with large scale geothermal systems (cf.: K. Heller et al.: “A New Deep Geothermal Concept Based on the Geyser Principle”, PROCEEDINGS, Thirty-Ninth Workshop on Geothermal Reservoir Engineering, Stanford University, Stanford, Calif., Feb. 24-26, 2014, SGP-TR-202).

The system shown in FIG. 1 can provide copious amounts of thermal energy, but generally at temperatures lower than those employed in large steam-powered electrical power stations. However, lower temperature processes (Stirling, Organic Rankine) can convert 10-20% of the thermal energy into electricity, and associated technologies and equipment exist that are well proven and mature.

In the case where the user unit on the surface is a desalination plant, the hot water delivered from the riser tunnel may be flash evaporated without further heating and condensed. Thermal desalination technology is mature and commercially available in many variants.

Generally, thermally driven processes shall require a cold sink to provide high efficiency. FIG. 2 shows how a parallel tunnel (13) carrying cold water at shallow depth h₂ below the surface of the body of water (1). The term “cold water” in the present context is meant to signify a temperature which is adequate for providing cooling in desalination processes as well as in geothermal electricity generation, and may typically correspond to ambient temperatures in or at the surface of the landmass where the underground hydraulic system is located. The cold water is branched off at points (14) via the control units (11). Cold water may be derived from the same body of water (1) as shown in FIG. 2, but may also be derived from a local source, e.g. a lake or river, instead of being transported across long distances via a tunnel.

In FIG. 3, the underground hydraulic system is set up to generate hydroelectric power: In analogy with the cases shown in FIG. 1 and FIG. 2, water enters the system via the intake tunnel (2), is geothermally heated in the layer (12) and then pumped up by the gas lift effect via the riser tunnel (6). In the case where the water contains dissolved salts, the first user unit (15) may perform desalinization and other operations before sending the water down the turbine tunnel (19) with a turbine (20) located near the lower end. The turbine drives a generator which generates electrical power. As can be seen from FIG. 3, the underground hydraulic system comprises several loops, where each loop includes a riser tunnel (6), a user unit and a turbine tunnel (19) with a turbine (20). In operation, the last riser tunnel (21) in the chain delivers hot water to the user unit (18) which removes water from the system. This provides room for water to pass through the turbine (20) in the preceding loop in the chain, where water is fed into the turbine shaft from the user unit (17). The latter receives water from the associated riser tunnel (6), which in turn draws water from the distribution channel (5), thus providing room for water to pass through the turbine (20), and so forth. This chain of events is made possible by the pumping action in each loop, and is dependent on water being removed from the last riser tunnel (21). The water thus removed may be used for driving thermally dependent processes in the user unit (18) or for applications requiring desalinated water. Alternatively, the water may be guided back to the user unit (15), where it may be re-injected into the system. In the latter case, the requirement for intake of fresh water or desalination is reduced.

Water temperatures in each turbine tunnel can be adjusted in the user units by making use of the heat content for purposes as described above. Hot water may also be returned down the turbine tunnels, as long as this does not damage the turbines.

This may be done to maintain adequate temperatures in the riser tunnels further down the chain.

1. An underground hydraulic system arranged in a landmass, comprising the following:
an intake tunnel (2) connected to a body of water (1) with a surface, where the intake tunnel (2) comprises an intake opening at one end and inclines towards an outlet opening at the other end, where the intake opening provides access to the intake tunnel (2) for water from the body of water (1);
a control unit (3) arranged to control flow of water from the body of water (1) into the intake tunnel (2);
a distribution tunnel (5) connected to the intake tunnel (2) at the outlet opening, and arranged at an average depth h₁ below the surface of the body of water (1) which is greater than that of the intake opening, where the distribution tunnel is arranged at least partially in a geological layer (12) with a temperature in a range of 40° C. and above, geothermally heating water in the distribution tunnel (5);
at least one riser tunnel (6) connected at a lower end to the distribution tunnel (5) and extending towards the surface of the landmass, where the at least one riser tunnel is arranged for receiving water from the distribution tunnel (5), where water in the riser tunnel (6) is pumped up by the hydrostatic pressure at the lower end of the at least one riser tunnel (6), generated by the cumulative head of water through the body of water (1), the intake tunnel (2) and the distribution tunnel (5), and in addition one or more of the following: the gas lift effect, and the thermally generated density differential effect.

2. The underground hydraulic system according to claim 1, where h₁ is larger than 1 km.

3. The underground hydraulic system according to claim 2, further comprising the following:
a user unit (7) connected to the riser tunnel (6), allowing water in the riser tunnel (6) entering the user unit (7); and
a riser control unit (11) arranged related to the riser tunnel (6), the riser control unit (6) controlling water flow into the user unit (7) above.

4. The underground hydraulic system according to claim 1, where a mechanical pump is arranged for assisting in pumping water upwards in the riser tunnel (6).

5. The underground hydraulic system according to claim 4, where the control unit (3) comprises at least one of the following: filtration systems and sensors for parameters.

6. The underground hydraulic system according to claim 5, where the parameters comprise at least one of the following: salinity, temperature, turbidity and pressure.

7. The underground hydraulic system according to claim 1, further comprising a turbine unit (4, 20) arranged related to one of the tunnels (2, 5, 19) for producing hydroelectric energy from water flow in the tunnel.

8. The underground hydraulic system according to claim 1, further comprising:
a second distribution tunnel (13) essentially parallel to the first distribution channel (5), but at less depth h₂, below the surface of the body of water (1) transporting water under hydrostatic pressure from the body of water, and connected at branching off points (14) to one or more of the riser control units (11).

9. The underground hydraulic system according to claim 1, further comprising:
at least one water transport loop comprising at least one user unit (16) being connected to a turbine tunnel (19) where water from the riser tunnel (6) is redirected from the user unit (16) and through a water turbine (20) located in the turbine tunnel (19), and where a lower part of the turbine tunnel (19) connects with a distribution tunnel (5) which delivers water to a second water transport loop in a chain of two or more loops, in which the last user unit (18) in the chain drains water from the chain by transporting the received water away or by re-injecting the water into the first user unit in the chain.

10. The underground hydraulic system according to claim 2, where a mechanical pump is arranged for assisting in pumping water upwards in the riser tunnel.

11. The underground hydraulic system according to claim 3, where a mechanical pump is arranged for assisting in pumping water upwards in the riser tunnel.

12. The underground hydraulic system according to claim 2, further comprising a turbine unit arranged related to one of the tunnels for producing hydroelectric energy from water flow in the tunnel.

13. The underground hydraulic system according to claim 3, further comprising a turbine unit arranged related to one of the tunnels for producing hydroelectric energy from water flow in the tunnel.

14. The underground hydraulic system according to claim 4, further comprising a turbine unit arranged related to one of the tunnels for producing hydroelectric energy from water flow in the tunnel.

15. The underground hydraulic system according to claim 5, further comprising a turbine unit arranged related to one of the tunnels for producing hydroelectric energy from water flow in the tunnel.

16. The underground hydraulic system according to claim 6, further comprising a turbine unit arranged related to one of the tunnels for producing hydroelectric energy from water flow in the tunnel.

17. The underground hydraulic system according to claim 6, further comprising a turbine unit arranged related to one of the tunnels for producing hydroelectric energy from water flow in the tunnel.

18. The underground hydraulic system according to claim 10, further comprising a turbine unit arranged related to one of the tunnels for producing hydroelectric energy from water flow in the tunnel.

19. The underground hydraulic system according to claim 11, further comprising a turbine unit arranged related to one of the tunnels for producing hydroelectric energy from water flow in the tunnel.

20. The underground hydraulic system according to claim 2, further comprising:
a second distribution tunnel essentially parallel to the first distribution channel, but at less depth h₂, below the surface of the body of water transporting water under hydrostatic pressure from the body of water, and connected at branching off points to one or more of the riser control units.
